(19) United States
(12) Patent Application Publication
(10) Pub. No.: US 2003/0121778 A1
(43) Pub. Date: Jul. 3, 2003

(54) Apparatus for and method of making electrical measurements on an object

(76) Inventors: John Dodgson, Surrey (GB); Lars Thomsen, Molndal (SE)

Correspondence Address: WHITE & CASE LLP, PATENT DEPARTMENT, 1155 AVENUE OF THE AMERICAS, NEW YORK, NY, 10036, US

(21) Appl. No.: 10/168,597

(22) PCT Filed: Dec. 20, 2000
(86) PCT No.: PCT/GB00/04894

(30) Foreign Application Priority Data
Dec. 24, 1999 (GB) 99307191.1

(51) Int. Cl. G01N 27/26

(52) U.S. Cl. 204/401; 204/403.01

(57) ABSTRACT

This invention relates to an apparatus for and method of making electrical measurements on cells, liposomes or similar small objects suspended in a medium. More particularly the invention relates to an apparatus and method for making electrophysiological measurements on cells.

This invention relates to an apparatus for and method of making electrical measurements on cells, liposomes or similar small objects suspended in a medium. More particularly the invention relates to an apparatus and method for making electrophysiological measurements on cells.

Previously electrical measurements on small objects such as cells, liposomes or membrane fragments have been made using an electrolyte-filled micropipette or similar apparatus brought into contact with the object, a seal made between the object and the tip of the pipette such that the electrolyte inside the pipette contacts the object, a high electrical resistance being achieved in the seal, and the measurement made by monitoring current and potential between a first electrode contacting the electrolyte and a second electrode contacting a liquid bathing the object. The conventional procedure involves delicate manipulation and is labour-intensive and prone to failure. The present invention is intended to overcome this and other problems associated with the presently existing apparatus and method.

According to the present invention there is provided an apparatus for making electrical measurements on cells, liposomes or similar small objects suspended in a medium comprising: means for locating the object inside a test structure, means for establishing a seal between the object and a wall of the test structure, means for monitoring the integrity of the seal, means for measuring the electrical characteristics of the object located inside the test structure, and means for changing the composition of the liquid in the vicinity of the object, on one or both sides of the seal.

Preferably a characteristic dimension of a test structure within which the object is located is of the order of 50 μm, more preferably it is less than 25 μm. Preferably a characteristic dimension of the region in which the object is sealed at the seal position is of the order of 10 μm.

Objects or cells are introduced into the test structure entrained in liquid by way of a pump or gravity feed or other suitable liquid displacement mechanism.

Preferably the test structure within which the object is located comprises an orifice through which a liquid contacts the object. Preferably the orifice has a shape which allows the object to seal readily to a sealing surface near to or around the orifice. In particular, the test structure is preferably hollowed or tapered to allow the object to deform so as to fit to the taper., Preferably the test structure within which the object is located is formed of a material to which the object will readily form a seal. Alternatively the area to which the object is intended to be sealed is coated with a sealant material which will enhance the seal. Most preferably that sealant material is a glass, for example borosilicate glass. Preferably the test structure is a pipette, drawn to an appropriate shape using a conventional pipette puller, but drawn in such a way as to produce a more rapid taper from a wide bore to a narrow orifice than is necessary or is common practice in the prior art. Preferably the orifice is less than 5 μm in diameter. Preferably the taper of the structure is such that at 50 μm from the orifice the internal diameter of the structure is of the order of 10 μm; more preferably it is greater than 10 μm. The object will then deform to seal to the walls as it moves down through the test structure towards the orifice. It will seal at a distance from the orifice which depends on parameters which include the diameter and taper of the test structure, the diameter of the object, its compressibility, the adhesive interaction between the object and the walls of the test structure and the pressure applied. These parameters can be adjusted to suit the type of object under test, if this is known, or might be determined to be a mean such that the majority of objects of a population under test will seal to the test structure at an appropriate distance from the orifice. The parameters, and the taper of the test structure are chosen so that the object seals as close as is practical to the orifice.

Electrodes are provided to make contact with liquid inside the structure in a channel leading to the orifice, and to the liquid surrounding the portion of the test structure on the other side of the orifice.

Means are provided for measuring the electrical impedance between the electrodes in order to detect the presence of a cell or other object in the vicinity of the orifice, to monitor the presence and quality of a seal between the object and the seal area inside the test structure, and the electrical properties of the object when exposed to controlled amounts of chemical species in the solutions on either side of the orifice.

Preferably there is provided a plurality of the aforementioned test structures arranged in an array. An advantage of such an array is that many objects may be acted upon in parallel to increase the throughput of testing. The side of the orifice in each test structure opposite to the side on which the object under test is sealed is preferably in communication with a common manifold contacting other test structures in the array. This manifold preferably contains an electrolyte contacting all the objects in common via the orifices of the test structure, and capable of being used to apply suction to the structures in order to draw the object down towards the orifice, and then to establish a seal between the object and the wall of the test structure. In some test procedures suction might be applied to rupture the cell membrane or empty the cell, leaving an attached membrane fragment. Optionally an electrical pulse might be applied between the electrodes to permeabilise the portion of the membrane closest to the orifice. Chemical agents might be delivered via the manifold, through the orifice and so to the object sealed inside the test structure. In particular, such an agent might serve to render the portion of the membrane of the cell nearest the orifice permeable to ions or other species, or to change its electrical properties in order to facilitate measurements on the other part of the membrane.

It is envisaged that given the variation in the likely parameters of objects such as cells from a population, the properties of the seal formed between cells and the test structures will vary from one case to another. In such an array, certain of the positions will establish a good seal and certain will not. It is envisaged in the invention that the apparatus will test the impedance of the seal to determine its integrity, and exclude the failed positions from tests.

As more objects are located in the test structures the pressure differential between the manifold and the atmosphere increases because fewer open orifices are available through which fluid may flow. This increased pressure tends to force objects into the test structures if they deform relatively easily. Means might be provided to obtain an indication of structures which are occupied and use this information to reduce or increase the pressure differential.

The use of robotics to deliver the objects to the test structures is advantageous in that the need for precise manipulation by an operator is removed. Preferably fluid flow arrangements in the test structures are such that the objects will be carried to the seal position structures by the fluid flow, and be ready for tests without further actuation within the apparatus. Optionally however other forms of actuation might be employed, for example, electrical or mechanical actuation, for example by dielectrophoretic movement, or piezoelectric mechanical actuation. Both these forms are well known in the art.

Electronic logic may be used to monitor the location of objects at the test positions and to control the process of establishing and maintaining the seal, and then to measure the electrical characteristics of the object. The logic circuitry may be integrated within a semiconducting substrate, for example using CMOS, DMOS or bi-polar components, fabricated in a convenient process sequence as known in the art. Optionally the processing means responds to an external indication of the presence or state of an object at the test position. The indication may in turn be derived by image processing means such as a video microscope image of the channel, to detect the presence of a cell to be tested.

It is intended that the test structures should be used once only and then discarded. This will ensure that a good seal is achievable every time between the object and the wall of the structure, without the possibility of disruption by contamination of the walls resulting from previous tests. The test structures and manifold array holder are therefore designed to give an easily achieved fit of the test structure into the array holder, which allows a pressure differential to be maintained across the test structure and electrical contact to be made to the orifice of the test structure. Placing test structure in the array might be done manually or by robot.

Further embodiments of the test structures include arrays of test structures permanently bonded together, for example by gluing into a matrix. These might have the orifice formed either before or after assembly of the array. In the case that the test structure is a pulled glass pipette, the array of pipettes might be pulled jointly after the glass capillaries have been bonded together into an array at their two ends. Alternative structures might be formed by sintering glass capillaries and/or rods together to form an array, then pulling them to form capillaries.

Embodiments of the invention will now be described, by way of examples only, and with reference to the following Figures in which:

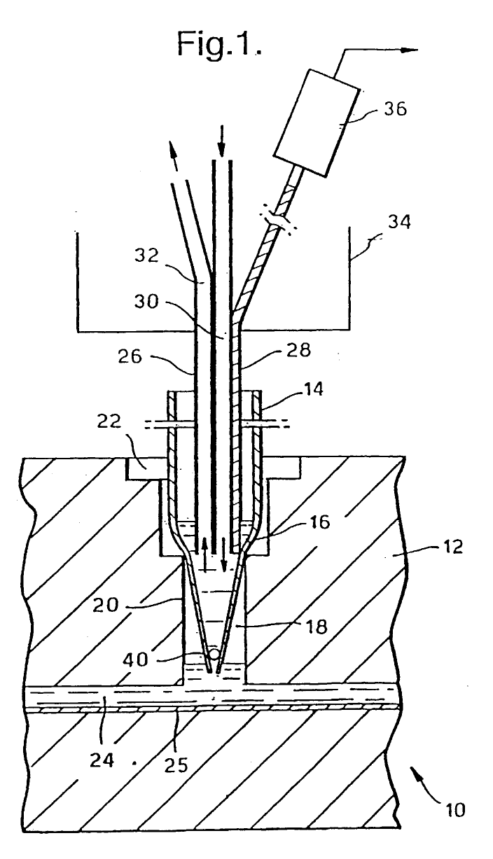

FIG. 1 is a cross section of a first embodiment of a test structure according to the invention in position in a manifold and contact array holding apparatus.

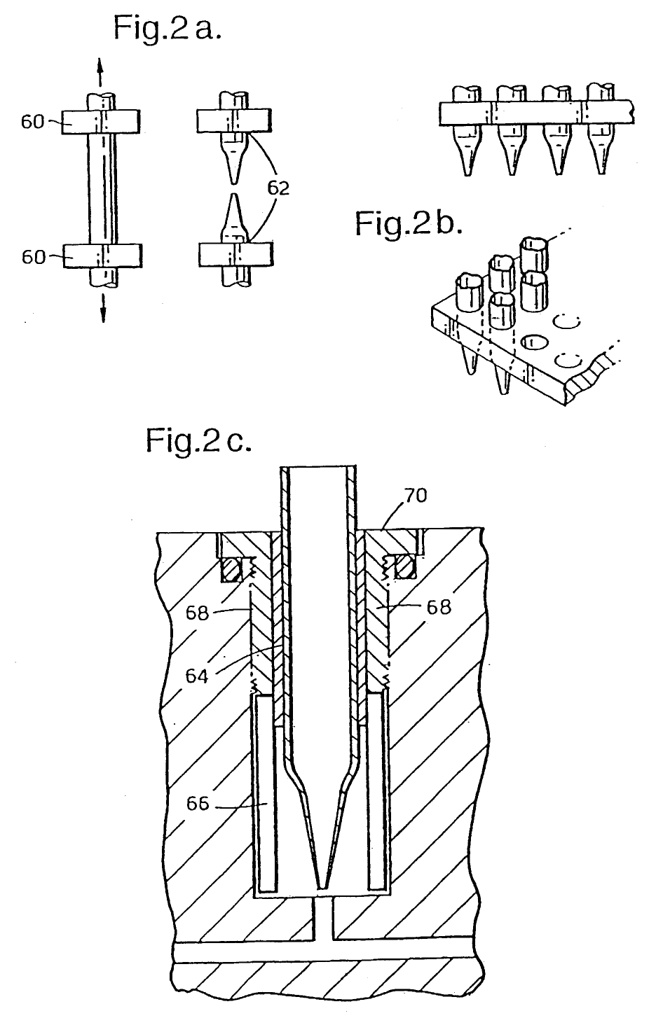

FIG. 2 shows further possible embodiments of test structures according to the invention.

Referring to the figures, the various embodiments and their operation will be described with regard to tests on cells, it being understood that this shall refer also in each case to tests on other similar small objects.

FIG. 1 shows a test position 10 in a holding structure 12 which is designed to accommodate a number of test structures, in this case pulled borosilicate glass pipettes 14. These are the same as conventional pipettes except that they are pulled to have a much sharper taper in the shoulder region 16 of the pipette than normal, and a shorter taper region 18, as described above. The holding structure 12 has a well 20 which accommodates the pipette and gasket 22 to give a suction seal between the pipette and the well. The gasket is for example an o-ring mounted to the wall of the well, or part of a plastic component mounted around the pipette body. A manifold or channel 24 is provided which, in use, fills the well with electrolyte up to the point that it contacts further electrolyte inside the pipette through the pipette tip. An Ag/AgCl electrode 25 is in contact with the electrolyte in manifold Z to provide electrical contact to the tip side of the pipette. Electrode 25 might be located in the vicinity of the orifice as shown, or might be in contact with the solution some way distant from it. A contact and solution supply means 26 is located such that it can be lowered into the pipette. This has a second Ag/AgCl electrode 28 to contact the solution inside the pipette, a solution supply tube 30 and a solution withdrawal tube 32 to wash solutions through the inside of the pipette, all mounted on a robotic head 34 which is used to lower the contact and solution supply means into the pipette. Connection is made from electrode 28 to a preamplifier 36 and thence to measuring apparatus (not shown). The well 20 is designed to position the pipette at the correct height above the channel 24 (for example using a step as shown in FIG. 1), which intercepts the shoulder of the pipette so that only moderate care is needed in placing the pipette in the well. It, is envisaged that the pipettes be located at a standard microtitre plate format spacing to fit present robotic liquid dispensing designs.

In use a the pipette is placed into the well and electrolyte flowed through the channel 24 into the well. Some of the electrolyte will move up through the pipette tip by capillary action. Solution containing a cell 40 to be tested is dispensed into the pipette by the robot head 34. The system checks for electrical contact through the tip and monitors the impedance between electrodes 25 and 28. A slight suction is applied to channel 24 in order to draw solution down through the pipette, and anchor the cell in the tip. The suction might be controlled by feedback from measurements of the impedance between the electrodes. The pipette might be coated inside so as to reduce the tendency for the cell to stick other than in the tip. Increased suction is applied and this will effect a seal between the cell membrane and the inside of the pipette wall.

A good seal is shown by a sufficiently high impedance and this is checked for by the system. Any position which does not form an adequate seal is noted by the system and data from it ignored. The cell is then exposed to a sequence of solutions via the tubes 30 and 32 and its response recorded. After the test the pipette is withdrawn and discarded.

FIG. 2 shows variants on the design of the pipette test structure which could be used to increase throughput and practicality in large sets of experiments. For ease of handling and forming a suction seal to the array holder a moulded plastic component 60 is optionally provided around the shank of the capillary as in FIG. 2a. This might be done before pulling the capillary, as shown, giving two capillaries after pulling with ready formed sealing surfaces 62 on the undersides of the moulded components which contact seal faces on the array holder. An array of capillaries might be formed bonded together as in FIG. 2b, in which case a single sealing surface might be provided round the edge of the array. FIG. 2c shows a further embodiment that is optional and preferable in cases where the tips of the capillaries might be damaged after pulling. A plastic component moulded or otherwise attached around the shank of the capillary comprises two parts, 64, which is attached to the capillary, and 66, which is attached to 64 and in capable of sliding over 64 into an extended position (as shown in FIG. 2c) and guided by grooves in the outer surface of 64, with a lock mechanism which holds 66 in the extended position once this has been reached. Before the capillary is pulled, 66 is supplied retracted over 64 (in the dotted position in FIG. 2c) leaving the pulling area free for the heating and pulling operation. After pulling, 66 is slid forward over 64 into the extended position where it locks. Parts 66 are designed so that in the extended position 66 extends beyond the tip, enclosing it and protecting it from damage, making handling large numbers of pipettes an easy task. In use the assembly fits into a well in the assembly holder as shown, with a seal surface provided on a flange on part 64, and part 66 clear of the bottom of the well.

While glass pipettes have been referred to as the test structures of choice in the above description, other test structures are usable within the scope of the invention. Any machined or micromachined structure which comprises a plurality of adjacent wells, with lower outlets small enough to trap a cell, and upper outlets large enough to admit and electrode and solution, might be used. Such structures might be formed from materials which do not readily form seals to the cells or other objects which are to be tested. In this case, a coating might be applied to enhance the seal, for example a thin film of borosilicate glass might be deposited by e.g. sputtering or evaporation on the inside surface of the structure.

1. An apparatus for making electrical measurements on cells, liposomes or similar small objects suspended in a medium comprising. means for locating the object inside a test structure, the test structure comprising an orifice, means for establishing a seal between the object and a wall of the test structure at a distance from the orifice, means for monitoring the integrity of the seal, means for measuring the electrical characteristics of the object located inside the test structure, and means for changing the composition of the liquid in the vicinity of the object, on one or both sides of the seal

2. Apparatus as claimed in claim 1 wherein the means for establishing a seal is a sealant material coated onto the wall of the test structure.

3. Apparatus as claimed in any preceding claim wherein a liquid contacts the object through the orifice.

4. Apparatus as claimed in any preceding claim wherein the test structure comprises a rapid taper from a wide bore to the narrow orifice.

5. Apparatus as claimed in any preceding claim wherein the orifice is less than 5 μm in diameter.

6. Apparatus as claimed in any preceding claim wherein the means for measuring the electrical characteristics comprise electrodes, at least one electrode being present on either side of the seal.
